(19) United States
(12) Patent Application Publication
(10) Pub. No.: US 2011/0004732 A1
(43) Pub. Date: Jan. 6, 2011

(54) DMA in Distributed Shared Memory System

(75) Inventors: Shahe Hagop Krakirian, Palo Alto, CA (US); Isam Akkawi, Aptos, CA (US); I-Ping Wu, Pleasanton, CA (US)

Correspondence Address: Huawei Technologies Co., Ltd., IPR Dept., Building B1-3-A,, Huawei Industrial Base, Bantian, Shenzhen Guangdong, 518129, CN

(73) Assignee: 3Leaf Networks, Inc., Santa Clara, CA (US)

(21) Appl. No.: 11/758,919

(22) Filed: Jun. 6, 2007

(51) Int. Cl. G06F 12/00

(52) U.S. Cl. 711/147; 711/E12.001

(57) ABSTRACT

An example embodiment of the present invention provides processes relating to direct memory access (DMA) for nodes in a distributed shared memory system with virtual storage. The processes in the embodiment relate to DMA read, write, and push operations. In the processes, an initiator node in the system sends a message to the home node where the data for the operation will reside or presently resides, so that the home node can directly receive data from or send data to the target server, which might be a virtual I/O server. The processes employ a distributed shared memory logic circuit that is a component of each node and a connection/communication protocol for sending and receiving packets over a scalable interconnect such as InfiniBand. In the example embodiment, the processes also employ a DMA control block which points to a scatter/gather list and which control block resides in shared memory.

### CROSS-REFERENCE TO RELATED APPLICATIONS

This application is related to the following commonly-owned U.S. utility patent application,, whose disclosure is incorporated herein by reference in its entirety for all purposes: U.S. patent application Ser. No. 11/668,275, filed on Jan. 29, 2007, and entitled “Fast Invalidation for Cache Coherency in Distributed Shared Memory System”.

### TECHNICAL FIELD

The present disclosure relates to a process for direct memory access (DMA) in a distributed shared memory (DSM) system.

### BACKGROUND

Distributed Shared Memory (DSM) is a multiprocessor system in which the processors in the system are connected by a scalable interconnect, such as an InfiniBand or Ethernet switched fabric communications link, instead of a bus. DSM systems present a single memory image to the user, but the memory is physically distributed at the hardware level across individual computing nodes. Typically, each processor has access to a large shared global memory in addition to a limited local memory, which might be used as a component of the large shared global memory and also as a cache for the large shared global memory. Naturally, each processor will access the limited local memory associated with the processor much faster than the large shared global memory associated with other processors. This discrepancy in access time is called non-uniform memory access (NUMA).

A major technical challenge in DSM systems is ensuring that the each processor's memory cache is consistent with each other processor's memory cache. Such consistency is called cache coherence. To maintain cache coherence in larger distributed systems, additional hardware logic (e.g., a chipset) or software is used to implement a coherence protocol, typically directory-based, chosen in accordance with a data consistency model, such as strict consistency. DSM systems that maintain cache coherence are called cache-coherent NUMA (ccNUMA). Typically, if additional hardware logic is used, a node in the system will comprise a chip that includes the hardware logic and one or more processors and will be connected to the other nodes by the scalable interconnect.

DMA is a feature of modern computers that allows certain hardware subsystems within a computer to access system memory for reading and/or writing independent of the central processing unit (CPU). Many hardware systems use DMA including storage devices, network cards, graphics cards, and sound cards. Without DMA, the CPU would need to copy each piece of data from the source to the destination. And during this time, the CPU would be unavailable for other tasks involving access to the CPU bus, although the CPU could continue with work that did not require such access.

A DMA transfer copies a block of memory from one device to another. While the CPU initiates the transfer, it does not execute the transfer. For “third party” DMA, which is typically used with an ISA (Industry Standard Architecture) bus, the transfer is performed by a DMA controller which is part of the motherboard chipset. More advanced bus designs such as PCI (Peripheral Component Interconnect) typically use bus-mastering DMA, where the device takes control of the bus and performs the transfer itself. The classic use for DMA is copying a block of memory from system RAM to or from a buffer on a storage device, though as suggested above DMA has now become important for network operations.

Scatter/gather I/O (also known as vectored I/O) is a method of input and output by which a single procedure call sequentially writes data from multiple buffers to a single data stream or reads data from a data stream to multiple buffers. The buffers are given in a vector of buffers, sometimes called a scatter/gather list. Scatter/gather refers to the process of gathering data from, or scattering data into, the given set of buffers. The I/O can be performed synchronously or asynchronously. The main reasons for using scatter/gather I/O are efficiency and convenience. Scatter/gather I/O is often used in conjunction with DMA.

### SUMMARY

In particular embodiments, the present invention provides methods, apparatuses, and systems directed to DMA in a DSM system. In one particular embodiment, the present invention provides processes for DMA in a DSM system that uses DSM-management chips and virtual I/O servers.

### DESCRIPTION OF THE DRAWINGS

FIG. 1 is a diagram showing a DSM system with virtual storage, which system might be used with some embodiments of the present invention.

FIG. 2 is a diagram showing a ccNUMA DSM system, which system might be used with some embodiments of the invention.

FIG. 3 is a diagram showing some of the physical and functional components of an example DSM-management chip (or logic circuit), which chip might be used as part of a node with some embodiments of the present invention.

FIG. 4 is a diagram showing the format of a DMA control block (DmaCB), which format might be used in some embodiments of the present invention.

FIG. 5 is a diagram showing the formats of RDP packets for DMA operations, which formats might be used in some embodiments of the present invention.

FIG. 6 is a sequence diagram of an example process for performing a DMA read, which process might be used with an embodiment of the present invention.

FIG. 7 is a sequence diagram of an example process for performing a DMA write, which process might be used with an embodiment of the present invention.

FIG. 8 is a sequence diagram of an example process for performing a DMA push, which process might be used with an embodiment of the present invention.

FIG. 9 is a diagram showing a flowchart of an example process which an initiator node might use when performing a DMA read, in some embodiments of the present invention.

FIG. 10 is a diagram showing a flowchart of an example process which an initiator node might use when performing a DMA write, in some embodiments of the present invention.

FIG. 11 is a diagram showing a flowchart of an example process which target node software might use when performing a DMA read, in some embodiments of the present invention.

FIG. 12 is a diagram showing a flowchart of an example process which target node software might use when performing a DMA write, in some embodiments of the present invention.

FIG. 13 is a diagram showing a flowchart of an example process which target node hardware (e.g., the DMM in a DSM-management chip) might use when performing a DMA read, in some embodiments of the present invention.

FIG. 14 is a diagram showing a flowchart of an example process which target node hardware (e.g., the DMM in a DSM-management chip) might use when performing a DMA write, in some embodiments of the present invention.

### DESCRIPTION OF EXAMPLE EMBODIMENT(S)

The following example embodiments are described and illustrated in conjunction with apparatuses, methods, and systems which are meant to be examples and illustrative, not limiting in scope.

### A. ccNUMA DMA System with DSM-Management Chips

A distributed shared memory system (DSM) has been developed that provides cache-coherent non-uniform memory access (ccNUMA) through the use of a DSM-management chip which is part of each node in the DSM system and which implements the coherence protocol. The DSM system allows the creation of a multi-node virtual server which is a virtual machine consisting of multiple CPUs belonging to two or more nodes. The nodes in the DSM system use a proprietary connection/communication protocol called Reliable Delivery Protocol (RDP) to communicate with each other and with virtual input/output servers (virtual I/O servers). Implementation of the RDP protocol is also handled by the DSM-management chip.

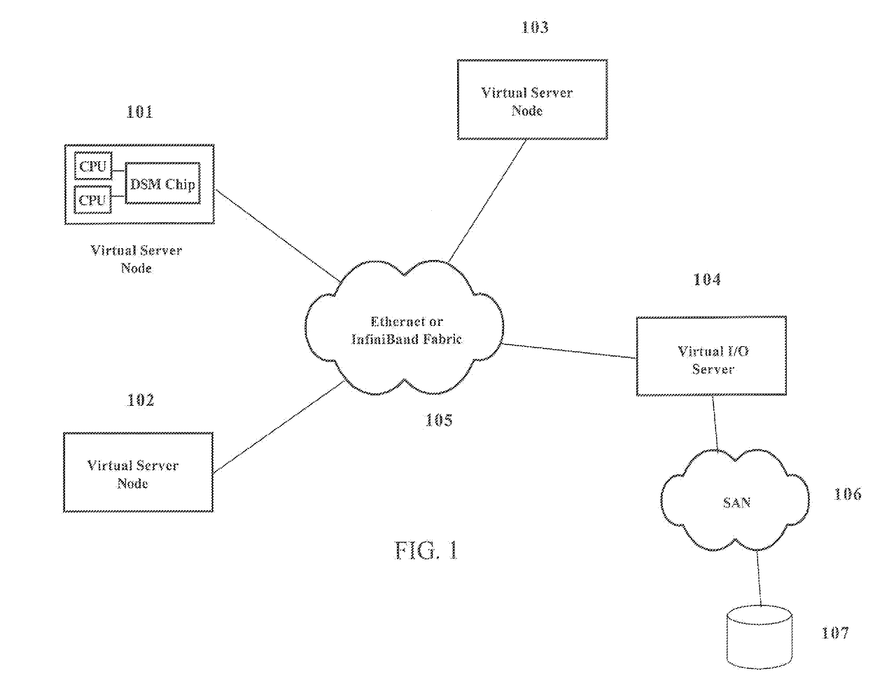

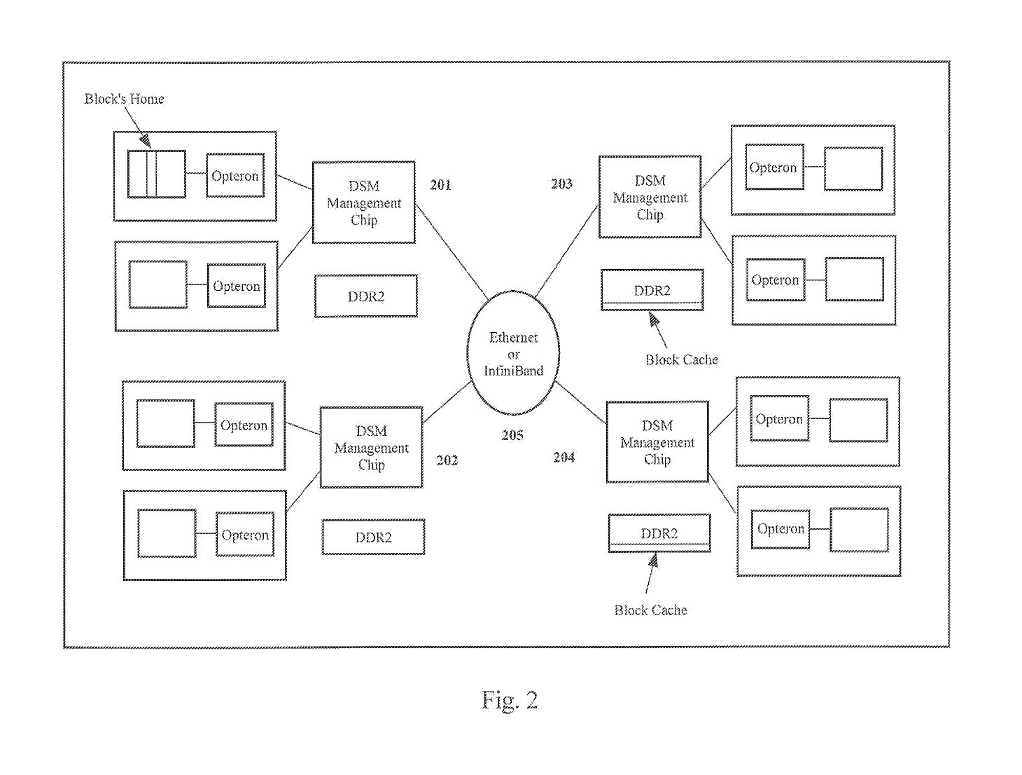

FIG. 1 is a diagram showing a DSM system with virtualized I/O subsystem access (e.g., networking and storage), which system might be used in some embodiments of the present invention. The system includes three nodes 101, 102, and 103 and a virtual I/O server 104. which are connected by an Ethernet or InfiniBand fabric 105. As shown by node 101, each of the nodes contains a DSM-management chip and two CPUs, as explained further below. In particular embodiments, virtual I/O server 104 might also include a DSM-management chip, though a virtual I/O server 104 does not contribute any physical memory to the DSM system and consequently does not make use of the chip's functionality directly related to cache coherence.

As shown in FIG. 1, virtual I/O server 104 may be connected to one to a plurality of I/O subsystems, such as mass storage devices, network interlace controllers, and storage area network (SAN) 106, as is storage device 107. Virtual I/O servers 104 are described in the commonly-owned U.S. Provisional Patent Application No. 60/796,116, entitled “Virtual Input/Output Server”, whose disclosure is hereby incorporated by reference for all purposes. Virtual I/O server 104, in one implementation, is operative to proxy interactions between the compute nodes and the one or more attached I/O subsystems. As the foregoing illustrates, the virtual I/O server 104, relative to the DMA operations discussed herein may be an initiator or a target device. In some embodiments, the virtual I/O server 104 itself may use a form of DMA to transfer data to (and from) its non-shared memory from (and to) one or more I/O subsystems, such as a storage device or network interface.

FIG. 2 is a diagram showing a ccNUMA DSM system, which system might be used with a particular embodiment of the invention. In this DSM system, four nodes (labeled 201, 202, 203, and 204) are connected to each other over an Ethernet or InfiniBand fabric (labeled 205). In turn, each of the four nodes includes two Opteron CPUs, a DSM-management chip, and memory in the form of DDR2 S DRAM: (double-data-rate two synchronous dynamic random access memory). In this embodiment, each Opteron CPU includes a local main memory connected to the CPU. This DSM system provides NUMA (non-uniform memory access) since each CPU can access its own local main memory fester than it can access the other memories shown in FIG. 2. It will be appreciated that the nodes in other embodiments might be built with a CPU that is not an Opteron CPU but which is a suitable substitute, e.g., a CPU which includes local memory connected to the CPU

Also as shown in FIG. 2, a block of memory has its “home” in the local main memory of one of the Opteron CPUs in node 201. That is to say, this local main memory is where the system's version of the memory block is stored, regardless of whether there are any cached copies of the block. Such cached copies are shown in the DDR2s for nodes 203 and 204. The DSM-management chip includes hardware logic to make the DSM system cache-coherent (i.e., ccNUMA) when multiple nodes are caching copies of the same block.

### B. System Architecture of a DSM-Management Chip

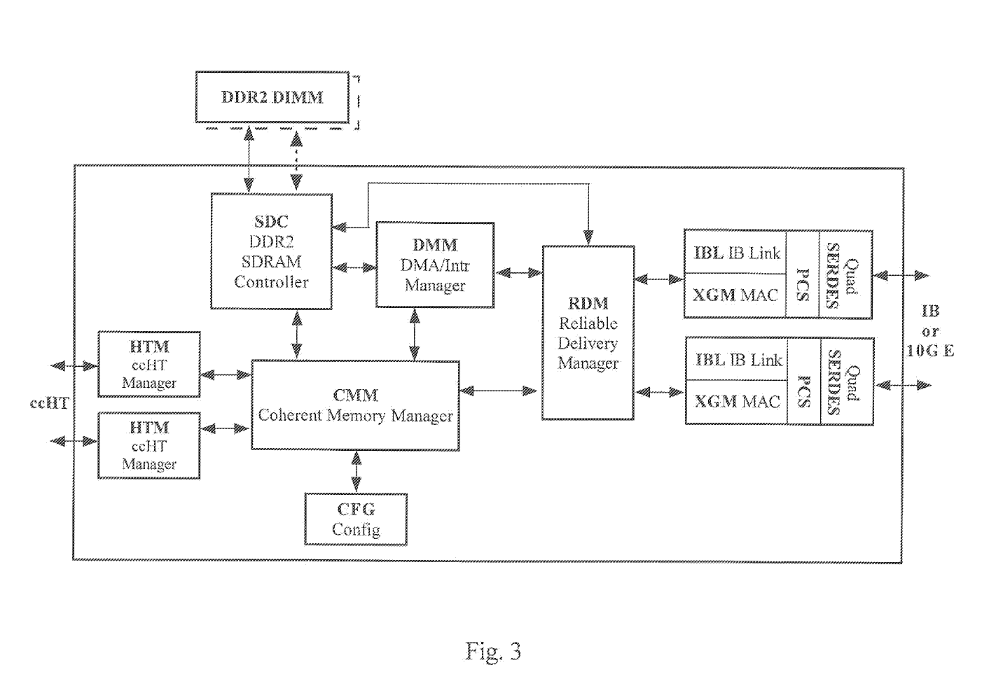

FIG. 3 is a diagram showing the physical and functional components of a DSM-management chip, which chip might be used as part of a node in particular embodiments of the invention. The DSM-management chip includes two HyperTransport Managers (BTMs), each of which manages the chip's communications to and from a CPU (e.g., an AMD Opteron) over a ccHT (cache coherent HyperTransport) bus, as is shown in FIG. 2. More specifically, an HTM provides the PHY and link layer functionality for a ccHT interface. The HTM captures all received ccHT packets in a set of receive queues (e.g., posted/non-posted command, request command, probe command and data) which are consumed by the Coherent Memory Manager (CMM). The HTM also captures packets from the CMM in a similar set of transmit queues and transmits those packets on the ccHT interface. As a result of the HTM, the DSM-management chip becomes a coherent agent with respect to any bus snoops broadcast over the ccHT bus by a memory controller. It will be appreciated that an HTM might provide similar functionality to any other suitable microprocessor and any other suitable bus.

Also as shown in FIG. 3, the two BTMs are connected to a Coherent Memory Manager (CMM), which provides cache-coherent access to memory for the nodes that are part of the DSM fabric. In addition to interfacing with the Opteron processors through the HTM, the CMM interfaces with the fabric via the RDM (Reliable Delivery Manager). Additionally, the CMM provides interfaces to the HTM for DMA (Direct Memory Access) and configuration.

The RDM manages the flow of packets across the DSM-management chip's two fabric interface ports. The RDM has two major clients, the CMM and the DMA Manager (DMM), which initiate packets to be transmitted and consume received packets. The RDM ensures reliable end-to-end delivery of packets using the proprietary protocol, Reliable Delivery Protocol (RDP). On the fabric side, the RDM interfaces to the selected link/MAC (XGM for Ethernet, IBL for InfiniBand) for each of the two fabric ports. In particular embodiments, the fabric might connect nodes to other nodes. In other embodiments, the fabric might also connect nodes to virtual I/O servers.

The XGM provides a 10G Ethernet MAC function, which includes framing, inter-frame gap handling, padding for minimum frame size, Ethernet FCS (CRC) generation and checking, and flow control using PAUSE frames. The XGM supports two link speeds: single data rate XAUI (10 Gbps) and double data rate XAUI (20 Gbps). The DSM-management chip has two instances of the XGM, one for each fabric port. Each XGM instance interfaces to the RDM, on one side, and to the associated PCS, on the other side.

The IBL provides a standard 4-lane IB link layer function, which includes link initialization, link state machine, CRC generation and checking, and flow control. The IBL block supports two link speeds, single data rate (8 Gbps) and double data rate (16 Gbps), with automatic speed negotiation. In particular embodiments, the DSM-management chip has two instances of the IBL, one for each fabric port. Each IBL instance interfaces to the RDM, on one side, and to the associated Physical Coding Sub-layer (PCS), on the other side.

The PCS, along with an associated quad-serdes, provides physical layer functionality for a 4-lane InfiniBand SDR/DDR interface, or a 10G/20G Ethernet XAUI/10GBase-CX4 interface. In particular embodiments, the DSM-management chip has two instances of the PCS, one for each fabric port. Each PCS instance interfaces to the associated IBL and XGM.

The DMM shown in FIG. 3 manages and executes direct memory access (DMA) operations over RDP, interfacing to the CMM block on the host side and the RDM block on the fabric side. For DMA, the DMM interfaces to software through the DmaCB table in memory and the on-chip DMA execution and completion queues, which will be described further below. In particular embodiments, parts of the DMA processes described below might be executed by the DMM. The DMM also handles the sending and receiving of RDP interrupt messages and non-RDP packets, and manages the associated inbound and outbound queues.

The DMM has two DMA execution queues that, are used to receive DMA execution requests from software: the Outbound DMA execution queue (O_DmaExecQ) and the Inbound DMA execution queue (I_DmaExecQ). The outbound queue is used for DMA read tasks on the target side and DMA write and push tasks on the initiator side. The inbound queue is used for DMA read tasks on the initiator side, and DMA write and push tasks on the target side. The DMM also has a completion queue (DmaComp1Q) for each Interrupt ID (IntrId) value. These queues are used to report task completion and/or error termination status to the local software on the target side. The queue element for both queue types contains a LocalTaskTag value, i.e., an index to the associated DmaCB in system memory.

The DDR2 SDRAM Controller (SDC) attaches to an external 240-pin DDR2 SDRAM DIMM, which is actually external to the DMS-management chip, as shown in both FIG. 2 and FIG. 3. In particular embodiments, the SDC provides SDRAM access for the CMM and the DMM.

In some embodiments, the DSM-management chip might comprise an application specific integrated circuit (ASIC), whereas in other embodiments the chip might comprise a field-programmable gate array (FPGA). Indeed, the logic encoded in the chip could be implemented in software for DSM systems whose requirements might allow for longer latencies with respect to maintaining cache coherence, DMA, interrupts, etc.

### C. DMA Control Block (DmaCB)

In some embodiments, there are three types of DMA operations or tasks: read, write, and push. A DMA task is managed by an initiator (typically a virtual server node or standalone server) and a target (typically a virtual I/O server). A DMA task is created through the exchange of one or more interrupt messages between the initiator and target, and is executed mostly by the DMM in the DSM-management chip on each side based on a DMA Control Block (DmaCB) created by software. The DMA task usually completes with an interrupt, message from target to initiator. DMA control blocks are stored in a table in system memory and are indexed by a task tag (e.g., InitTaskTag for the initiator, TargTaskTag for the target), genetically referred to as a LocalTaskTag.

The DmaCB includes both static and dynamic fields relating to scatter/gather lists. Each DmaCB points to a data buffer segment or a scatter/gather list of segments in system memory to be used for transferring the data. On the target side, the DMA buffers are all local to the node. On the initiator side, if the initiator node belongs to a distributed virtual server, the buffers may be distributed across one or more home nodes belonging to that server.

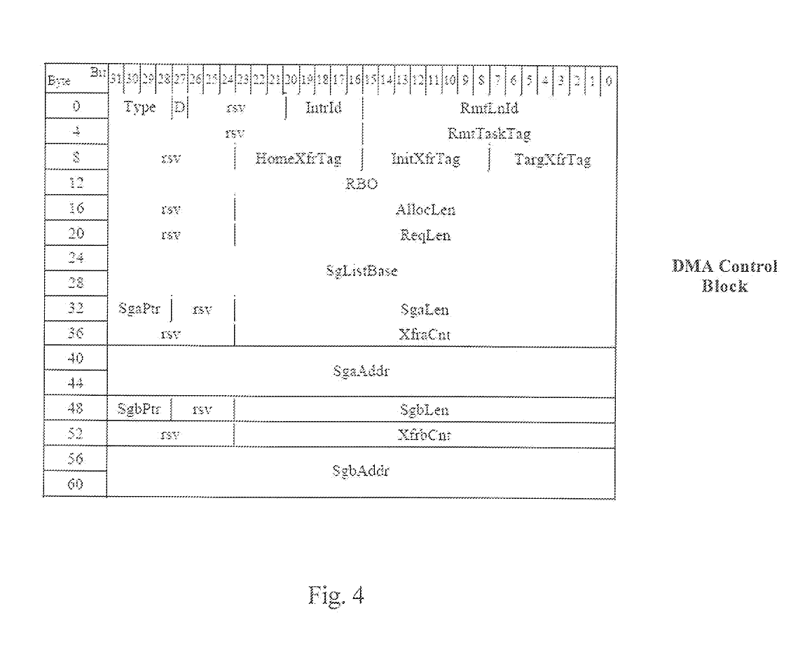

FIG. 4 is a diagram showing the format of a DMA control block (DmaCB), which format might be used in some embodiments of the present invention, in this format, the following static fields are set up by software:
Type—Specifies the DmaCB type as follows:
   Bit 3—DMA Context: 1 Initiator; 0 Target
   Bit 2—Reserved
   Bits 1:0—DMA Type: 0 Invalid; 1 Read; 2 Write; 3 Push
D—Direct Address: When set, indicates that a single contiguous data buffer is allocated for the DMA; the buffer address and length are specified by SgListBase and AllocLen, respectively.
When clear, a scatter/gather list of buffer segments is provided.
IntrId—Interrupt ID: A logical identifier that maps to a local CPU to be interrupted.
RmtLnId—Remote Logical Node ID.
RmtTaskTag—For a target DmaCB, this is the InitTaskTag. For a push DmaCB at the initiator, this is the TargTaskTag. Otherwise, this field is reserved.
AllocLen—Allocated buffer length in bytes for the DMA task. This is usually the total expected transfer length for the task, with the following exception. The total transfer length may be less than the allocated length: (a) for a read DmaCB at the initiator, if the DMA read task is set up ahead of time and is used for pushing target data to the initiator, or (b) for a push DmaCB at the target.
SgListBase—Scatter/Gather List Base Address when D is clear; data buffer address when D is set.

The following dynamic state fields are updated by the DSM-management chip, after being initialized to 0 by software:
HomeXfrTag—Home Transfer Tag is used to identify the DmaCB number for the home node.
InitXfrTag—Initiator Transfer Tag is used to identify the DmaCB number for the initiator node.
TargXfrTag—Target Transfer Tag is used to identify the DmaCB number for the target node.
RBO—Current byte offset relative to the first data byte of the task.
ReqLen—Request Length in bytes for the DMA task. This is DmaXfrLen field received in the DmaReq packets by Initiator Nodes or PushLen field received in the DmaPush packets by Target Node. This field is automatically updated by the DMM and should be initialized to zero by the software in the DmaCB, as noted above.
SgaLen—Remaining Length of the current scatter/gather segment.
SgaPtr—Bit 3 indicates if it is first time the scatter/gather being accessed by the DMM block, bit 2 indicates if SgaLen contains residue count, and bits 1-0 points to the current scatter/gather element of the corresponding on-chip scatter/gather list.
SgaAddr—Current address of the current scatter/gather segment. Not meaningful when SgaLen=0.
XfraCnt—This counter tracks the remaining transfer length with the Home Node associated with this DMA operation in Sga.
SgbLen—Same definition as SgaLen except that this is used for the second DMA operation when a target node is operating with 2 concurrently active scatter/gather elements.
SgbPtr—Same definition as SgaPtr except that this is used for the second DMA operation when a target node is operating with 2 concurrently active scatter/gather elements.
SgbAddr—Same definition as SgaAddr except that this is used for the second DMA operation when a target node is operating with 2 concurrently active scatter/gather elements.
XfrbCnt—This counter tracks the remaining transfer length with the Home Node associated with this DMA operation in Sgb.

### D. RDP Packets for DMA

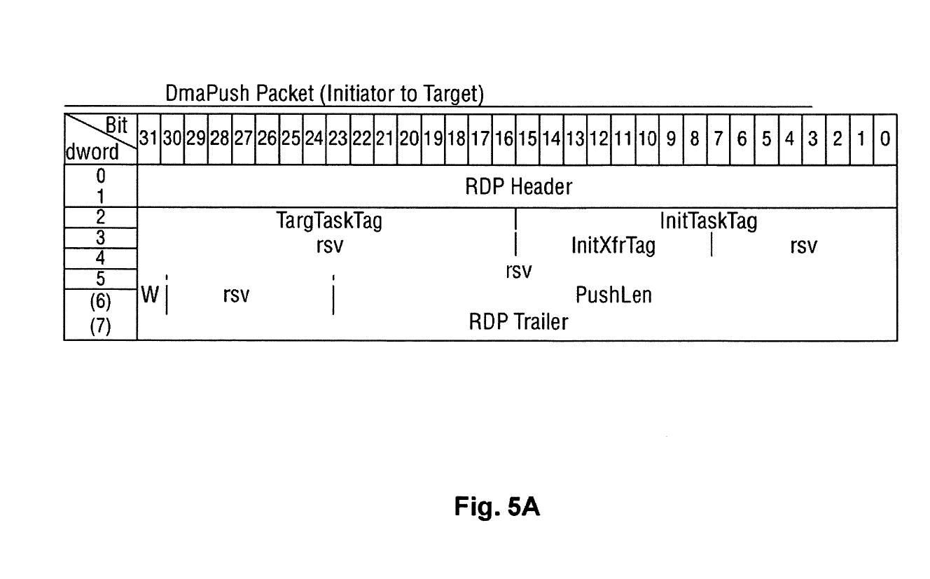

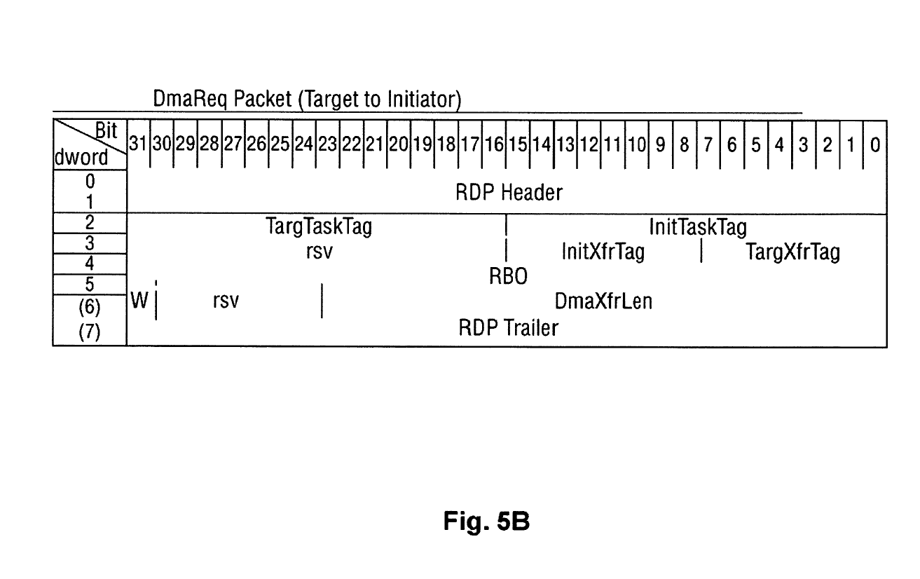

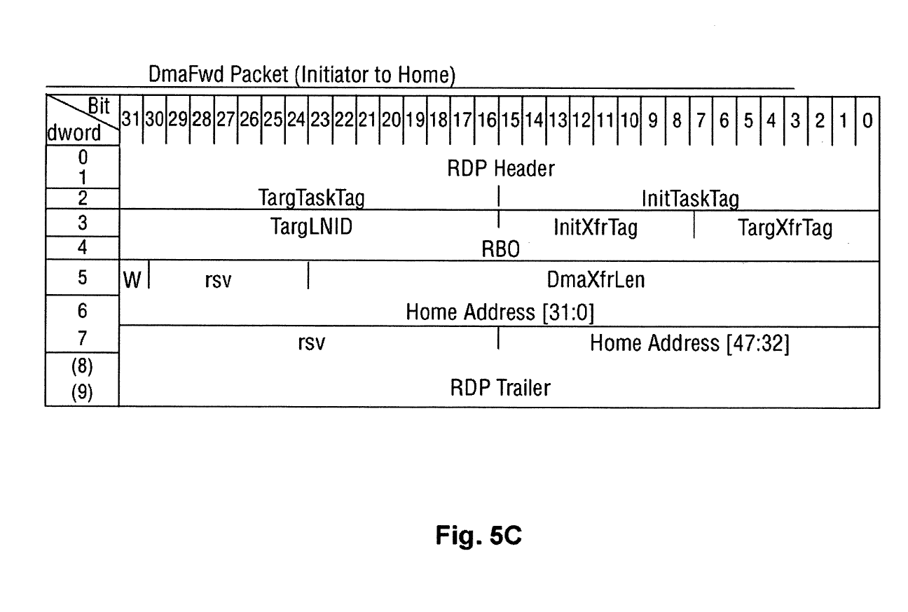

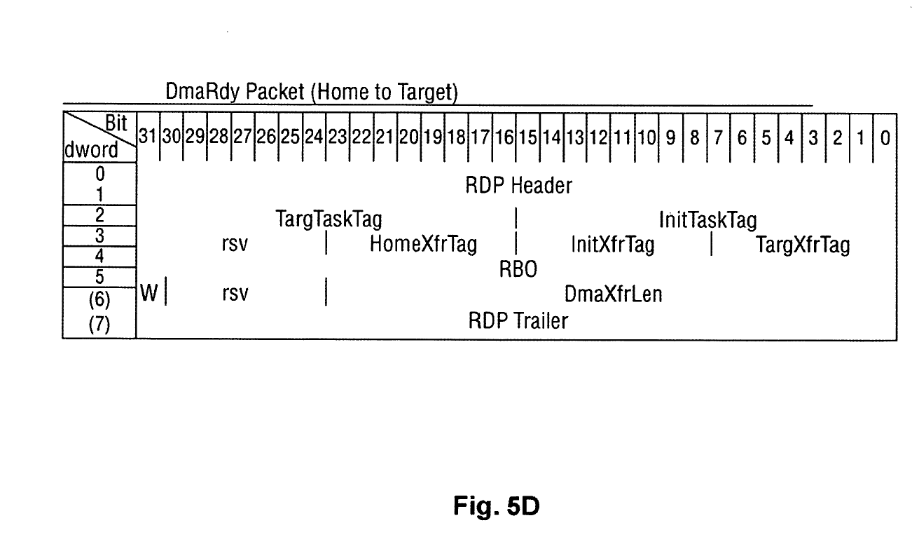

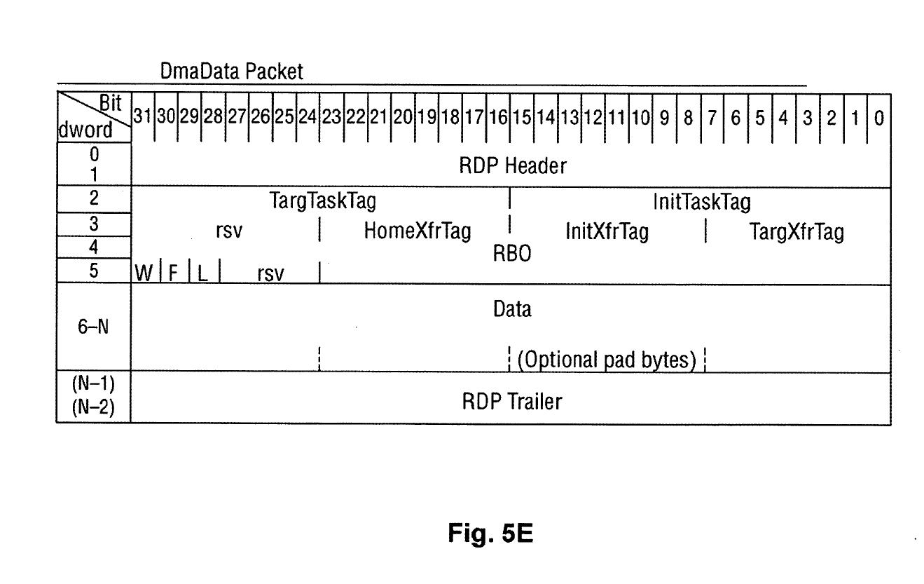

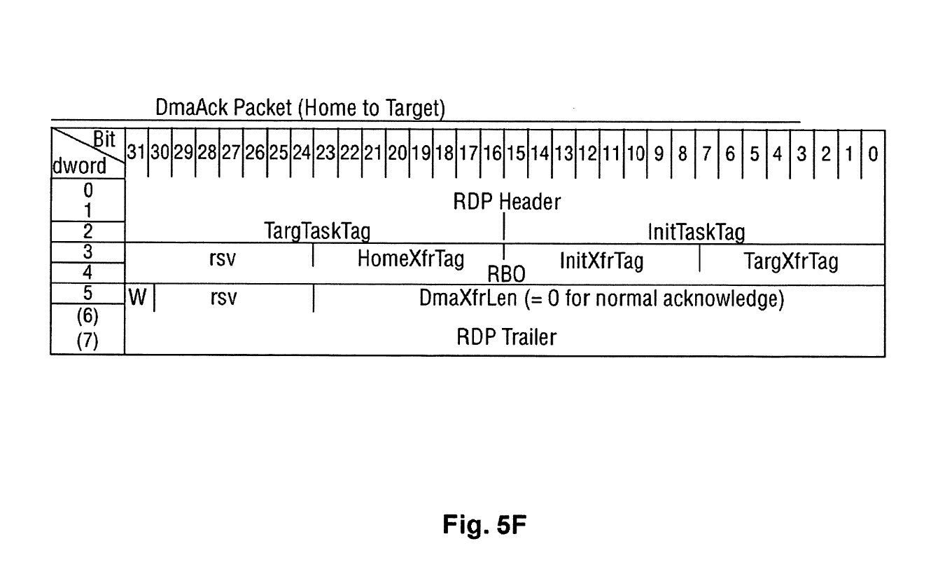

FIG. 5 is a diagram showing the formats of RDP packets for DMA operations, which formats might be used in some embodiments of the present invention. The RDP protocol includes six different formats for DMA packets, corresponding to the following tasks and subtasks: (a) DmaPush (Initiator to Target); (b) DmaReq (Target to Initiator); (c) DmaFwd (Initiator to Home); (d) DmaRdy (Home to Target); (e) DmaData; and (f) DmaAck (Home to Target).

In particular embodiments, the fields used in one or more of these formats include the following:
Data—1 to 128 bytes of user data followed by 0 to 3 trailing pad bytes in a DmaData packet. Pad bytes are present typically in the last DmaData packet of a transfer (DmaXfrLen is less than or equal to the Data field size). When pad bytes are present, the DmaXfrLen field will specify the number of valid user data bytes in the Data field,
DmaXfrLen—DMA Transfer Length: The desired length of a DMA transfer in bytes. The target specifies its desired length in the DmaReq packet, but the initiator or home node may reduce it by returning a smaller value in a DmaRdy or DmaData packet to the target. In a DmaData packet, this field indicates the remaining transfer length for the current DMA transfer, including the data in the current packet; if DmaXfrLen is less than or equal to the number of bytes in the Data field, then this is the last DmaData packet of the transfer. In a DmaAck packet, DmaXfrLen equals the remaining transfer length of received read data that was not successfully committed to memory in the home node. Thus, a value of zero indicates the successful completion of the DMA transfer, whereas a non-zero value indicates a failure in committing all the data to memory.
F—- First Data Packet: This bit is set for the first DmaData packet of a DMA transfer and cleared otherwise. If a DMA transfer has only one DmaData packet, then the F and L bits are both set for that packet.
HomeXfrTag—Home Transfer Tag: A tag for a DMA transfer assigned by the home node. This is typically a DMA channel ID in the home node.
InitTaskTag—Initiator Task Tag: A tag for the DMA task assigned by the initiator. The lower bits of the InitTaskTag are typically used as an index to a DMA control block in the initiator node's memory. The upper bits can be used as a generation number for the control block for protection against access by stale of malformed packets.
InitXfrTag—Initiator Transfer Tag: An optional tag for a DMA transfer assigned by the initiator. This may be an index to a DMA control block that, is cached by hardware in the initiator node. A value of 0 means the tag is unassigned. InitXfrTag is unassigned (0) in a DmaReq packet from the target except for the following two cases. First, for an initiator push transfer, the target may receive a valid InitXfrTag in the DmaPush packet; if so, the target will use it in the responding DmaReq packet. Second, for a continuation transfer, the DmaReq packet contains the InitXfrTag value previously assigned to the transfer that is being continued. A continuation transfer is executed if the initiator/home response to a previous request (DmaRdy or first DmaData packet) specifies a DmaXfrLen smaller than the original requested transfer length.
L—Last Data Packet: This bit is set for the last DmaData packet of a DMA transfer and cleared otherwise. If a DMA transfer has only one DmaData packet, then the F and L bits are both set for that packet.
PushLen—Push Length: Specifies the total number of bytes to be transferred for a DMA push task.
RBO—Relative Byte Offset: A byte offset relative to the beginning of the data for a DMA task. RBO is 0 for the first data byte of the DMA task. In a DmaAck packet, RBO is one plus the offset of the last received data byte that has been successfully committed to memory in the home node. If the DmaData packet for the ending data of the DMA task has pad bytes, then the RBO value in the DmaAck packet shall reflect the ending RBO of the last user data byte and shall exclude the pad bytes.
TargLNID—Target Logical Node ID—If the initiator belongs to a multi-node virtual server, this is the LNID assigned to the target by the virtual server.
TargTaskTag—Target Task Tag: A tag for the DMA task assigned by the target. The lower bits of the TargTaskTag are typically used as an index to a DMA control block in the target node's memory. The upper bits can be used as a generation number for the control block for protection against access by stale of malformed packets.
TargXfrTag—Target Transfer Tag: A tag for a DMA transfer assigned by the target. This is typically a DMA channel ID in the target node.
W—Write: Set if the packet is for a Write or Push transfer, clear for a Read transfer.

Through the use of tags such as InitTaskTag and TargTaskTag, RDP packets reference data set by software in DmaCB entries, as noted earlier. The RDP packet formats shown above facilitate operation of the DMA protocol for the DSM system.

### E. Sequences for DMA Operations

The DMA protocol, in a particular embodiment, is part of RDP and is used for transferring data between nodes. Other embodiments might use protocols other than RDP. The DMA protocol handles the data transfer for a DMA operation (task), DMA task command and status information is transferred using RDP interrupt messages. A DMA task involves an initiator node and target node. The initiator is typically an application server or virtual server node. The target is typically a virtual I/O server. As previously noted, the possible DMA task types are: read, write, and push. If the initiator is a member of a multi-node virtual server, it is possible that the data buffers for a DMA task are scattered across multiple home nodes (including or excluding the initiator node). Thus, one or more home nodes may be involved in the DMA data transfer. The data corresponding to each chunk of buffers residing on a home node is called a data group. The target is typically a single node system or a member of a multi-node system with the DMA mapped to unshared local memory.

A typical DMA read or write task proceeds as follows, in particular embodiments:
1. The initiator sends a DMA command to the target in the form of an interrupt message. The command specifies task attributes such as the I/O command to be issued to the ultimate I/O device (if any), transfer direction, and length.
2. One or more DMA transfers are executed to transfer all the data for the DMA task. The maximum data span of each transfer is a data group.
3. The target sends task: done status to the initiator in the form of an interrupt message. This occurs after delivery of all the data has been confirmed. In the case of a DMA write task, the target typically sends the task done message after the write data is successfully written to the ultimate target (e.g., storage device); the target may optionally send an earlier transfer done message when it has received all the write data.

A typical read or write DMA transfer (see the preceding paragraph 2) proceeds as follows, in particular embodiments:
1. The target sends a DMA request packet to the initiator requesting to transfer all or part of the data for the task. In some embodiments, the requested transfer size is greater than 0 bytes and less then or equal to 4,096 bytes.
2. If the requested data is not local (i.e., does not fully reside on the initiator node), then the DMA transfer is limited to the first data group only. If that data group resides on a home node that is different from the initiator node, then the initiator sends a DMA forward packet to the home node.
3. for a DMA read transfer:
a. The home node sends a DMA ready packet for the data group to the target. The DmaRdy packet indicates the actual transfer length that will be accepted by the home node.
b. The target sends the data to the home node through one or more DMA data packets.
c. When the home node has received all the data and written it to memory, it sends a DmaAck packet to the target.
4. For a DMA write transfer, the home node sends the data to the target through one or more DMA data packets. The first DmaData packet from the home node indicates the actual transfer length of the data that will be sent to the target. The transfer is complete when the target receives the last data packet.

Note that for either a read or write transfer, the transfer length indicated by initial response packet from the home node to the target (DmaRdy packet for read, first DmaData packet for write) may be less than or equal to the transfer length requested by the target in the DmaReq packet. The value will be less if the size of the data group on the home node is smaller than the requested length.

If the initial DMA transfer does not cover all of the data for the DMA task, then additional transfers are executed until all of the task data is transferred. DMA requests will request data in sequential order (i.e., continuously increasing byte offset). However, multiple DMA transfers can be concurrent within a task. In other words, when the target receives a response to its first DMA request (DMA ready packet for a read transfer or the first data packet of a write transfer), the target may issue the next request before all the data for the first request is transferred.

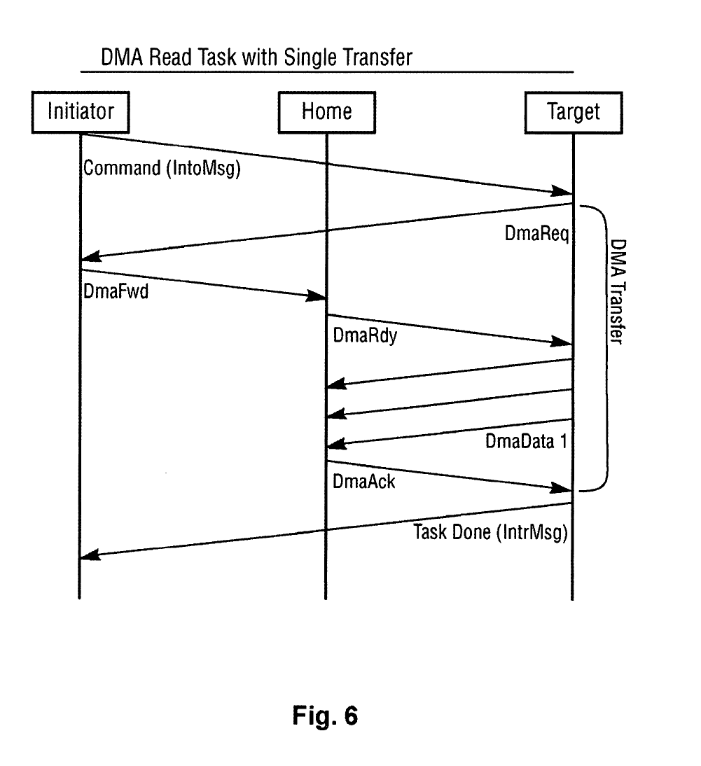

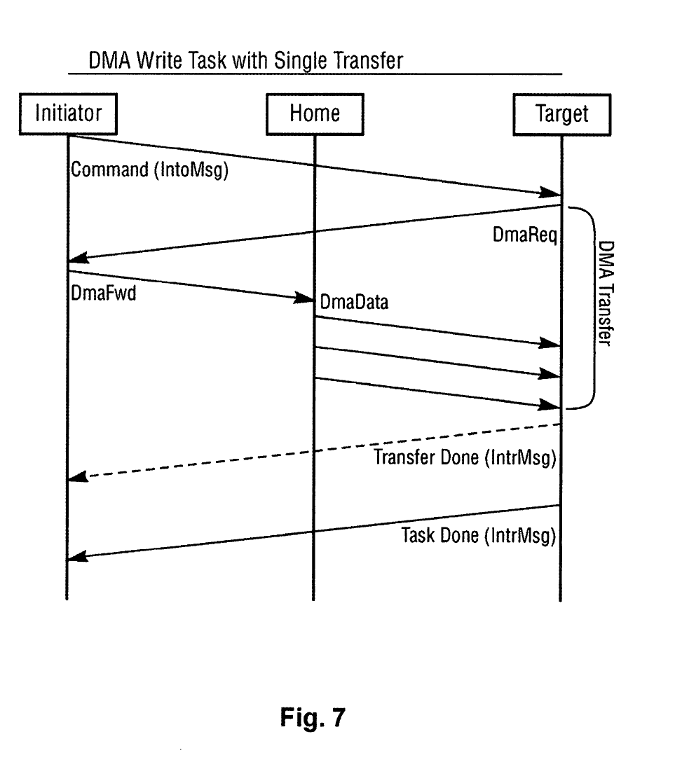

FIG. 6 is a sequence diagram of an example process for performing a DMA read task and FIG. 7 is a sequence diagram of an example process for performing a DMA write task, which processes might be used with an embodiment of the present invention. As indicated by the corresponding caption, each figure is limited to a task with single transfer, though this limitation is solely for pedantic purposes. A DMA read or write task might involve multiple transfers, as previously noted.

Further, as previously noted, a DMA read or write task might involve DMA between a virtual I/O server or other target and one or more I/O subsystems, such as a storage device or network interface, in some embodiments. For example, during a DMA read task, the virtual I/O server might buffer in memory data read using DMA from a storage device or system, before sending the data to a home node. And during a DMA write task, the virtual I/O server might buffer in memory data received from a home node, before sending the data using DMA to a storage device or system.

In particular embodiments, a typical DMA push task proceeds as follows:
1. The initiator sends a DMA command to the target in the form of an interrupt message. The command in this case is a request to pre-allocate a buffer for data to be pushed at a later time.
2. The target pre-allocates a buffer and acknowledges the command by sending an interrupt message to the initiator.
3. When the initiator has the data to send to the target it sends a DmaPush packet to the target.
4. One or more DMA write transfers are executed to transfer all the data for the DMA task.

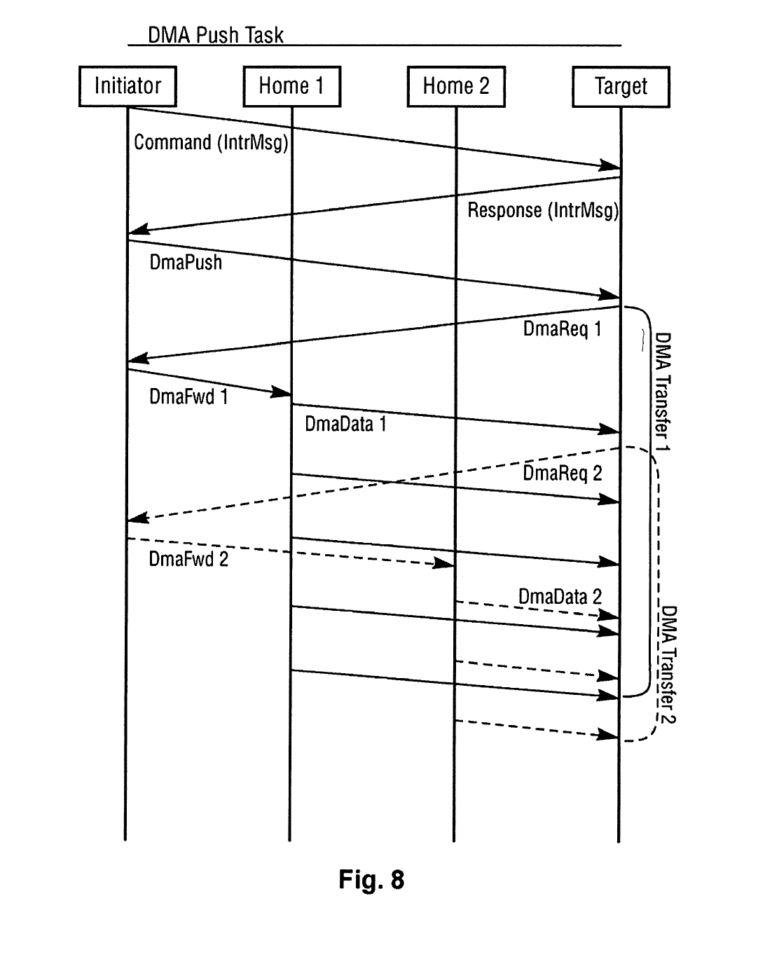

FIG. 8 is a sequence diagram of an example process for perforating a DMA push task. In some embodiments, it is possible to reduce the number of interrupts by setting up multiple DMA push tasks with a single two-way exchange of interrupt messages. That is to say, the initiator issues a single DMA command interrupt message for multiple tasks, and the target pre-allocates a buffer for each of those tasks before sending the acknowledge interrupt message back to the initiator.

### F. Processes for DMA Operations

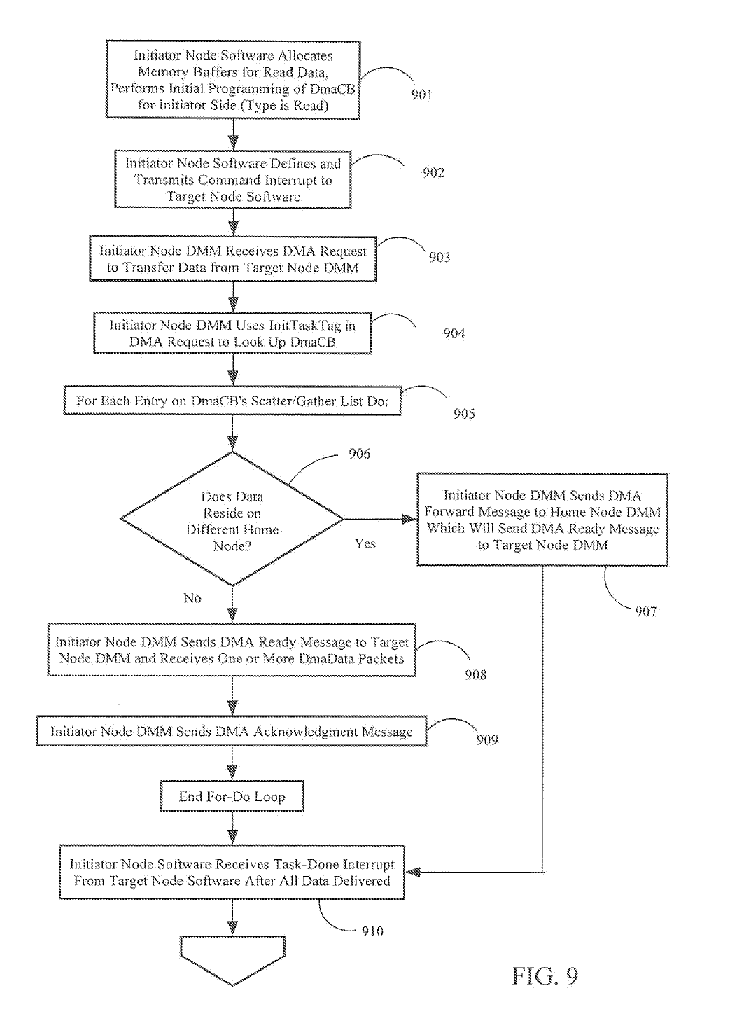

FIG. 9 is a diagram showing a flowchart of an example process which an initiator node might use when performing a DMA read, in some embodiments of the present invention. In the process's first step 901, the initiator node's software allocates memory buffers for the read data and performs initial programming of the DmaCB for the initiator side (the type of the DmaCB is set to “read”). In step 902 of the process, the initiator node's software defines and transmits a command interrupt to the target node's software which results in the initiator node's DMM receiving, in step 903, a DMA request to transfer data, which request was sent by the target node's DMM. Then in step 904 of the process, the initiator node's DMM uses the InitTaskTag in the DMA request to look up the DmaCB for the operation. In step 905 of the process, the initiator node's DMM launches an iteration over each entry in the scatter/gather list for the read data, which list is pointed to by the DmaCB. During each iteration, the initiator node's DMM determines whether the read data resides on a home node that is different from the initiator node, i.e., the DMM's node, in step 906. If so, in step 907, the initiator node's DMM sends a DMA forward message to the home node's DMM, which will send a DMA ready message to the target node's DMM. Otherwise, the initiator node's DMM itself sends a DMA ready message to target node's DMM and receives one or more DmaData packets from the target node's DMM, in step 908. Then, in step 909, once all the read data has received, the initiator node's DMM sends a DMA acknowledgment message to the target node's DMM. The iteration created in step 906 ends here. In the process's last step 910, the initiator node's software receives a task-done interrupt from the target node's software upon delivery of all the read data, possibly to a home node that is different from the initiator node.

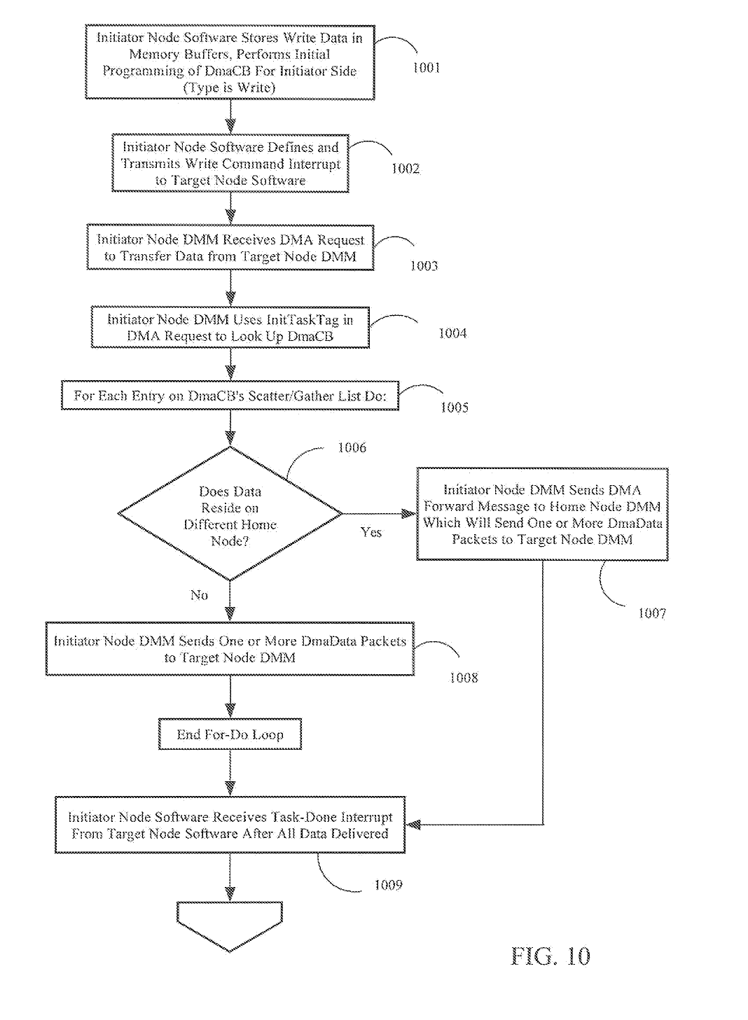

FIG. 10 is a diagram showing a flowchart of an example process which an initiator node might use when performing a DMA write, in some embodiments of the present invention. In the process's first step 1001, the initiator node's software stores the write data in memory buffers and performs initial programming of the DmaCB for the initiator side (the type of the DmaCB is set to “write”). In step 1002 of the process, the initiator node's software defines and transmits a command interrupt to the target node software which results in the initiator node's DMM receiving, in step 1003, a DMA request to transfer data, which request was sent by the target node's DMM. Then in step 1004 of the process, the initiator node's DMM uses the InitTaskTag in the DMA request to look up the DmaCB for the operation. In step 1005 of the process, the initiator node's DMM launches an iteration over each entry in the scatter/gather list for the write data, which list is pointed to by the DmaCB. During each iteration, the initiator node's DMM determines whether the write data resides on a home node that is different from the initiator node, i.e., the DMM's node, in step 1006. If so, in step 1007, the initiator node's DMM sends a DMA forward message to the home node's DMM, which will send one or more DmaData packets to the target node's DMM Otherwise, the initiator node's DMM itself sends one or more DmaData packets to target node's DMM, in step 1008. The iteration created in step 1005 ends here. In the process's last step 1009, the initiator node's software receives a task-done interrupt from the target node's software upon delivery of all the write data, possibly from a home node that is different, from the initiator node.

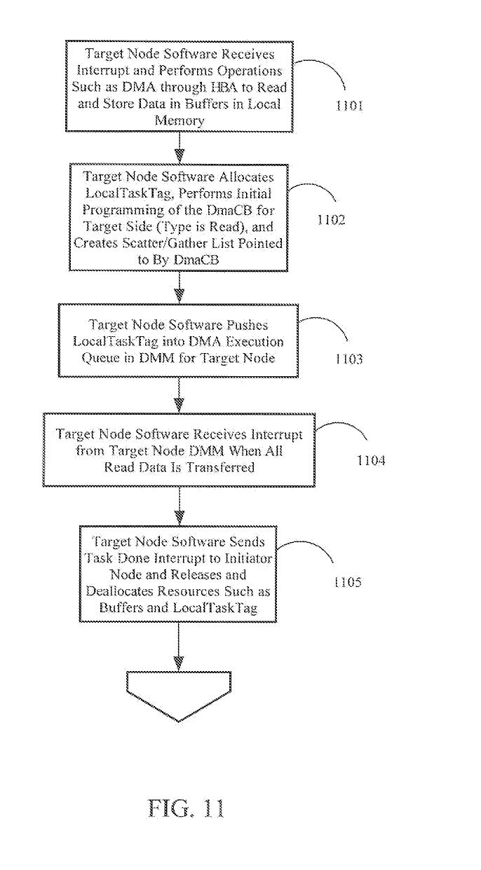

FIG. 11 is a diagram showing a flowchart of an example process which target node's software might use when performing a DMA read, in some embodiments of the present invention. In the process's first step 1101, the target node's software receives an interrupt from the initiator node software and performs operations such as DMA through HBA (host bus adapter) to read and store data in buffers in local memory. Then in step 1102, the target node's software allocates a LocalTaskTag, performs initial programming of the DmaCB for the target side (the type of the DmaCB is set to “read”), and creates a scatter/gather list for the read data, if needed, which list will be pointed to by the DmaCB. In step 1103, the target node's software pushes the LocalTaskTag into the DMA execution queue in the DMM for the target node, which begins the transfer of the read data as described above. In step 1104, the target node's software receives an interrupt from the target node's DMM once all the read data is transferred. The process ends in step 1105 when the target node's software sends a task-done interrupt to the initiator node's software and releases and deallocates resources such as buffers and the LocalTaskTag.

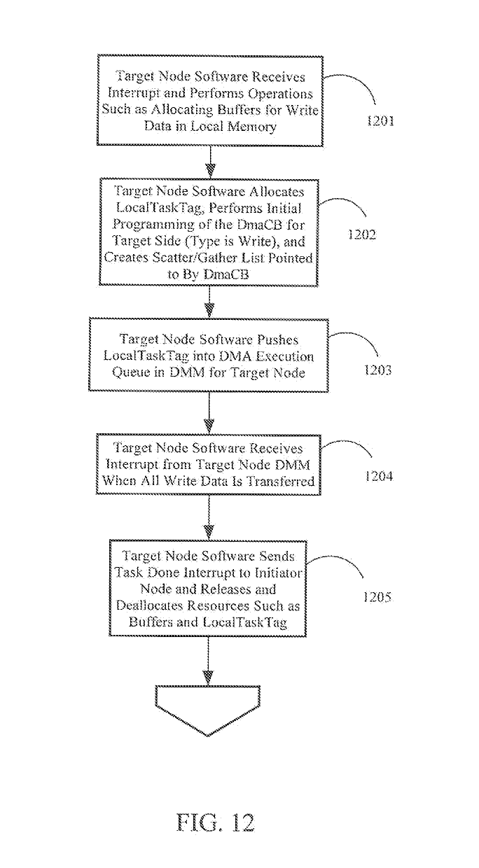

FIG. 12 is a diagram showing a flowchart of an example process which target node software might use when performing a DMA write, in some embodiments of the present invention. In the process's first step 1201, the target node's software receives an interrupt from the initiator node's software and performs operations such as allocating buffers for write data in local memory. Then in step 1202, the target node's software allocates a LocalTaskTag, performs initial programming of the DmaCB for the target side (the type of the DmaCB is set to “write”), and creates a scatter/gather list for the write data, if needed, which list will be pointed to by the DmaCB. In step 1203, the target node's software pushes the LocalTaskTag into the DMA execution queue in the DMM for the target node, which begins the transfer of the write data. In step 1204, the target node's software receives an interrupt from the target node's DMM once all the write data is transferred. The target node's software then performs operations such as DMA through an HBA (host bus adapter) to write the data from buffers in local memory to the ultimate destination of the write data (e.g., a hard disk drive). The process ends in step 1205 when the target node's software sends a task-done interrupt to the initiator node's software and releases and deallocates resources such as buffers and the LocalTaskTag,

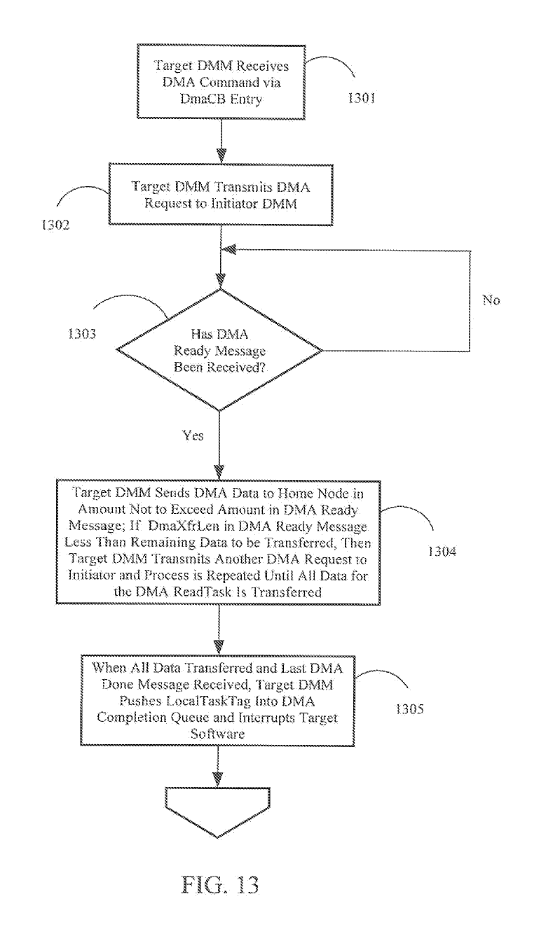

FIG. 13 is a diagram showing a flowchart of an example process which target node hardware (e.g., the DMM in a DSM-management chip) might use when performing a DMA read, in some embodiments of the present invention. In the process's first step 1301, the target node's DMM receives a DMA command via a DmaCB entry. In step 1302, the target node's DMM transmits a DMA request to the initiator node's DMM and then, in step 1303, does a busy wait until receiving back a DMA ready message. Upon receiving the DMA ready message, the target node's DMM goes to step 1304 and sends read data to the home node, in an amount not to exceed the amount in the DMA ready message. Once all the data has been delivered, the target node's DMM receives a DMA done message from the initiator. If DmaXfrLen in the DMA ready message was less than the remaining data to be transferred for the DMA read task, then the target node's DMM transmits another DMA request to the initiator and the process is repeated until all the data for the DMA read task has been transferred; the new DMA request, may optionally be sent immediately after receiving the previous DMA ready message from the initiator, before all the data is transferred for the previous DMA request. When all the data for the DMA read task h transferred and the last DMA done message h received, the target node's DMM pushes the LocalTaskTag into the DMA completion queue and interrupts the target node's software, in step 1305.

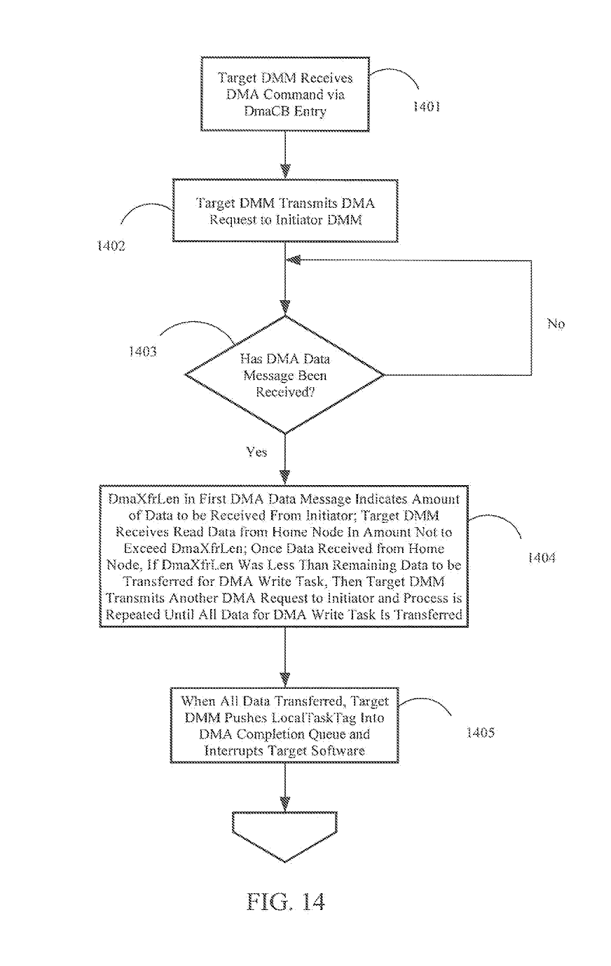

FIG. 14 is a diagram showing a flowchart of an example process which target node hardware (e.g., the DMM in a DSM-management chip) might use when performing a DMA write, in some embodiments of the present invention. In the process's first step 1401, the target node's DMM receives a DMA command via a DmaCB entry. In step 1402, the target node's DMM transmits a DMA request to the initiator node's DMM and then, in step 1403, does a busy wait until receiving back one or more DMA data messages. The DmaXfrLen in the first DMA data message indicates the amount of data to be received from the initiator. Upon receipt of the first DMA data message, the process goes to step 1404 and receives read data from the home node, in an amount not to exceed the DmaXfrLen value in the first DMA data message. Once all the data has been received, if DmaXfrLen in the first DMA data message was less than the remaining data to be transferred for the DMA write task, then the target node's DMM transmits another DMA request to the initiator and the process is repeated until all the data for the DMA write task has been transferred; the new DMA request may optionally be sent immediately after receiving the first DMA data message from the initiator, before all the data is transferred for the previous DMA request. When all the data for the DMA write task is transferred, the target node's DMM pushes the LocalTaskTag into the DMA completion queue and interrupts the target node's software, in step 1405.

In steps 1302 and 1402 above, the target node's DMM transmits one or more DMA requests to the initiator node's DMM. In particular embodiments, the number of such outstanding DMA requests (i.e., the number of DMA requests that have been sent and for which the DMA data transfer has not completed) per task is limited to two requests, with the size of each request limited to 4096 bytes. However, other embodiments do not include these limitations on number and size.

Particular embodiments of the above-described processes might be comprised, in part or in whole, of instructions that are stored in a storage media. The instructions might be retrieved and executed by a processing system. The instructions are operational when executed by the processing system to direct the processing system to operate in accord with the present invention. Some examples of instructions are software, program code, firmware, and microcode. Some examples of storage media are memory devices, tape, disks, integrated circuits, and servers. The term “processing system” refers to a single processing device or a group of inter-operational processing devices. Some examples of processing devices are integrated circuits and logic circuitry. Those skilled in the art are familiar with instructions, storage media, and processing systems.

Those skilled in the art will appreciate variations of the above-described embodiments that fall within the scope of the invention. In this regard, it will be appreciated that there are many other possible orderings of the steps in the processes described above and many other possible divisions of those steps between software and hardware. Also, it will be appreciated that within software, there are many possible modularizations of the processes, as is also true within hardware. Further, it will be appreciated that the above-described processes might apply to any DMA system, not only a DMA system involving DSM and virtual storage, and might execute on nodes whose CPUs are not Opterons. As a result, the invention is not limited to the specific examples and illustrations discussed above, but only by the following claims and their equivalents.

1. A method, comprising:
defining, at an initiating node in a non-uniform memory access (NUMA) distributed shared memory system with two or more nodes, a direct memory access (DMA) command seeking to read a block of data into one or more shared local memories residing on one or more nodes in the NUMA distributed shared memory system and transmitting the DMA command to a target server, wherein the target server stores the data to be read; and
iterating the following operations until completion of the DMA command:
receiving, at the initiating node, a DMA request from the target server to transfer data of the block of data from the target server, wherein the DMA request includes a tag which identifies a list of one or more shared memory addresses corresponding to one or more shared local memories residing on one or more nodes in the NUMA distributed shared memory system;
retrieving, at the initiating node, the list of one or more shared memory addresses from the tag and determining from the list whether the data to be read will be stored in shared local memory residing on the initiating node or on one or more other nodes in the NUMA distributed shared memory system;
sending, from the initiating node, a forwarding message to the one or more other nodes if the data to be read will be stored in shared local memory on the one or more other nodes, wherein the forwarding message causes the one or more other nodes to send a ready message to the target server and directly receive from the target server the data to be read; and
sending, from the initiating node, a ready message to the target server and receiving, at the initiating node, from the target server the data to be read and sending an acknowledgement to the target server, if the data will be stored in shared local memory at the initiating node.

2. The method of claim 1, wherein the list of one or more shared memory addresses is pointed to by a direct memory access control block in shared local memory and the tag is an index into the direct memory access control block.

3. The method of claim 1, wherein the target server creates the list of one or more shared memory addresses.

4. The method of claim 1, wherein sending the forwarding message is performed by a distributed shared memory logic circuit that is a component of the initiating node.

5. The method of claim 1, wherein the NUMA distributed shared memory system uses a connection and communication protocol implemented by a distributed shared memory logic circuit that is a component of each node.

6. The method of claim 1, wherein the target server is a virtual I/O server that logically stores the data to be read.

7. A method, comprising:
defining, at an initiating node in a non-uniform memory access (NUMA) distributed shared memory system with two or more nodes, a direct memory access (DMA) command seeking to write a block data from one or more shared local memories residing on one or more nodes in the NUMA distributed shared memory system and transmitting the DMA command to a target server, wherein the target server will store the data to be written; and
iterating the following operations until completion of the DMA command:
receiving, at the initiating node, a DMA request from the target server to transfer data of the block of data to the target server, wherein the DMA request includes a tag which identifies a list of one or more shared memory addresses corresponding to one or more shared local memories residing on one or more nodes in the NUMA distributed shared memory system;
retrieving, at the initiating node, the list of one or more shared memory addresses from the tag and determining from the list whether the data to be written is stored in shared local memory residing on the initiating node or on one or more other nodes in the NUMA distributed shared memory system;
sending, from the initiating node, a forwarding message to the one or more other nodes if the data to be written is stored in shared local memory on the one or more other nodes, wherein the forwarding message causes the one or more other nodes to send directly to the target server the data to be written; and
sending, from the initiating node, to the target server the data to be written, if the data is stored in shared local memory at the initiating node.

8. The method of claim 7, wherein the list of one or more shared memory addresses is pointed to by a direct memory access control block in shared local memory and the tag is an index into the direct memory access control block.

9. The method of claim 7, wherein the initiating node pre-allocates buffers on the target server through a previous message sent to the target server.

10. The method of claim 7, wherein the target server creates the list of one or more shared memory addresses.

11. The method of claim 7, wherein sending the forwarding message is performed by a distributed shared memory logic circuit that is a component of the initiating node.

12. The method of claim 7, wherein the NUMA distributed shared memory system uses a connection and communication protocol implemented by a distributed shared memory logic circuit that is a component of each node.

13. The method of claim 7, wherein the target server is a virtual I/O server that logically stores the data once it is written.

14. A computer program product comprising one or more computer-readable storage media having computer executable logic codes stored thereon and when executed operable to:
define, at an initiating node in a non-uniform memory access (NUMA) distributed shared memory system with two or more nodes, a direct memory access (DMA) command seeking to read a block of data into one or more shared local memories residing on one or more nodes in the NUMA distributed shared memory system and transmitting the DMA command to a target server, wherein the target server stores the data to be read; and
iterate the following operations until completion of the DMA command:
receive, at the initiating node, a DMA request from the target server to transfer data of the block of data from the target server, wherein the DMA request includes a tag which identifies a list of one or more shared memory addresses corresponding to one or more shared local memories residing on one or more nodes in the NUMA distributed shared memory system;
retrieve, at the initiating node, the list of one or more shared memory addresses from the tag and determining from the list whether the data to be read will be stored in shared local memory residing on the initiating node or on one or more other nodes in the NUMA distributed shared memory system;
send, from the initiating node, a forwarding message to the one or more other nodes if the data to be read will be stored in shared memory on the one or more other nodes, wherein the forwarding message causes the one or more other nodes to send a ready message to the target server and directly receive from the target server the data to be read; and
send, from the initiating node, a ready message to the target server and receive, at the initiating node, from the target server the data to be read and send an acknowledgement to the target server, if the data will be stored in shared local memory at the initiating node.

15. The computer program product of claim 14, wherein the list of one or more shared memory addresses is pointed to by a direct memory access control block in shared local memory and the tag is an index into the direct memory access control block.

16. The computer program product of claim 14, wherein the target server creates the list of one or more shared memory addresses.

17. The computer program product of claim 14, wherein the forwarding message is sent by a distributed shared memory logic circuit that is a component of the initiating node.

18. The computer program product of claim 14, wherein the NUMA distributed shared memory system uses a connection and communication protocol implemented by a distributed shared memory logic circuit that is a component of each node.

19. The computer program product of claim 14, wherein the target server is a virtual I/O server that logically stores the data to be read.

20. A computer program product comprising one or more computer-readable storage media having computer executable logic codes stored thereon and when executed operable to:
define, at an initiating node in a non-uniform memory access (NUMA) distributed shared memory system with two or more nodes, a direct memory access (DMA) command seeking to write a block of data from one or more shared local memories residing on one or more nodes in the NUMA distributed shared memory system and transmit the DMA command to a target server, wherein the target server will store the data to be written; and
iterate the following operations until completion of the DMA command:
receive, at the initiating node, a DMA request from the target server to transfer data of the block of data to the target server, wherein the DMA request includes a tag which identifies a list of one or more shared memory addresses corresponding to one or more shared local memories residing on one or more nodes in the NUMA distributed shared memory system;
retrieve, at the initiating node, the list of one or more shared memory addresses from the tag and determine from the list whether the data to be written is stored in shared local memory residing on the initiating node or on one or more other nodes in the NUMA distributed shared memory system;
send, from the initiating node, a forwarding message to the one or more other nodes if the data to be written is stored in shared local memory on the one or more other nodes, wherein the forwarding message causes the one or more other nodes to send directly to the target server the data to be written; and
send, from the initiating node, to the target server the data to be written, if the data is stored in shared local memory at the initiating node.

21. The computer program product of claim 20, wherein the list of one or more shared memory addresses is pointed to by a direct memory access control block in shared memory and the tag is an index into the direct memory access control block.

22. The computer program product of claim 20, wherein the initiating node pre-allocates buffers on the target server through a previous message sent to the target server.

23. The computer program product of claim 20, wherein the target server creates the list of one or more shared memory addresses.

24. The computer program product of claim 20, wherein the forwarding message is sent by a distributed shared memory logic circuit that is a component of the initiating node.

25. The computer program product of claim 20, wherein the distributed shared memory system uses a connection and communication protocol implemented by a distributed shared memory logic circuit that is a component of each node.

26. The computer program product of claim 20, wherein the target server is a virtual I/O server that logically stores the data once it is written.

27. A non-uniform memory access (NUMA) distributed shared memory system, comprising:
a plurality of nodes; and
a network fabric connecting the nodes,
wherein each node comprises local memory and logic encoded in one or more computer-readable media for execution and when executed operable to
share the local memory with other nodes of the NUMA distributed shared memory system,
initiate a direct memory access (DMA) command seeking to read a block of data from a target server,
implement, in connection with at least one other node, a DMA control block, wherein the DMA control block points to a list identifying one or more home nodes of the plurality of nodes that will store the block of data in local memory, and
iterate the following operations until completion of the DMA command:
receive a DMA request from the target server to transfer data of the block of data from the target server, wherein the DMA request includes a tag which identifies a list of one or more shared memory addresses corresponding to one or more shared local memories residing on the one or more nodes in the NUMA distributed shared memory system;
retrieve the list of one or more shared memory addresses from the tag and determine from the list whether the data to be read will be stored in shared local memory residing locally or on one or more other nodes in the NUMA distributed shared memory system;
send, from an initiating node, a forwarding message to one or more other nodes if the data to be read will be stored in shared local memory on the one or more other nodes, wherein the forwarding message causes the one or more other nodes to send a ready message to the target server and directly receive from the target server the data to be read; and
send, from the initiating node, a ready message to the target server and receive, at the initiating node, from the target server the data to be read and send an acknowledgement to the target server, if the data will be stored in shared local memory at the initiating node.

28. A non-uniform memory access (NUMA) distributed shared memory system, comprising:
a plurality of nodes; and
a network fabric connecting the nodes,
wherein each node comprises local memory and logic encoded in one or more computer-readable media for execution and when executed operable to
share the local memory with other nodes of the NUMA distributed shared memory system,
initiate a direct memory access (DMA) command seeking to write a block of data into a target server,
implement, in connection with at least one other node, a DMA control block, wherein the DMA control block points to a list identifying one or more home nodes of the plurality of nodes that store the block of data in local memory, and
iterate the following operations until completion of the DMA command:
receive a DMA request from the target server to transfer data of the block of data from the target server, wherein the DMA request includes a tag which identifies a list of one or more shared memory addresses corresponding to one or more shared local memories residing on the one or more nodes in the NUMA distributed shared memory system;
retrieve, at an initiating node, the list of one or more shared memory addresses from the tag and determine from the list whether the data to be written is stored in shared local memory residing locally or on one or more other nodes in the NUMA distributed shared memory system;
send, from the initiating node, a forwarding message to the one or more other nodes if the data to be written is stored in shared local memory on the one or more other nodes, wherein the forwarding message causes the one or more other nodes to send directly to the target server the data to be written; and
send, from the initiating node, to the target server the data to be written, if the data stored in shared local memory at the initiating node.
